(19) United States
(12) Patent Application Publication
(10) Pub. No.: US 2025/0020400 A1
(43) Pub. Date: Jan. 16, 2025

(54) DIFFUSER FOR DIFFUSING A GAS FLOW WITHIN A STACK OF BLANKS AND ASSOCIATED ASSEMBLIES

(71) Applicant: Safran Landing Systems, Velizy Villacoublay (FR)

(72) Inventors: Olivier MAURIGE, Moissy-Cramayel (FR); Patrice THOMAS, Moissy-Cramayel (FR)

(73) Assignee: Safran Landing Systems, Velizy Villacoublay (FR)

(21) Appl. No.: 18/712,755

(22) PCT Filed: Nov. 25, 2022
(86) PCT No.: PCT/FR2022/052179

§ 371 Date: May 23, 2024

(30) Foreign Application Priority Data
Nov. 25, 2021 (FR) 2112490

(51) Int. Cl. F26B 21/00; F26B 3/04

(52) U.S. Cl. CPC F26B 21/004; F26B 3/04; F26B 2210/02

(57) ABSTRACT

A diffuser for diffusing a gas flow within a stack of blanks that are impregnated with a sol-gel solution, the gas flow evaporating a solvent, each blank having a central through-opening, the openings forming a central well, includes diffusion fins extending from a central cavity toward the periphery of the diffuser, each fin having a central through-opening, the openings forming the open central cavity of the diffuser so as to form an upwardly open gas inlet, the cross section of the central cavity decreasing from the gas inlet, the fins extending into the central well, the fins diffusing and homogenizing the gas flow flowing from the central well through the stack.

### FIELD OF THE INVENTION

The invention relates to a device for drying impregnated blanks of parts based on carbon/carbon composite material, a system for impregnating blanks of parts based on carbon/carbon composite material with a sol-gel type solution in order to obtain blanks and for drying the impregnated blanks, and associated assembly and method.

### STATE OF THE ART

Parts based on carbon/carbon (C/C) composite material(s) are known.

These may include for example friction parts such as aircraft brake discs, but may also include other applications and/or parts made of C/C composite material, particularly those for which improved mechanical properties are sought. Aircraft brake discs made of C/C composite material are widely used. Indeed, due to the energies involved, the possible space requirement, and the importance of reducing the equipment mass, friction braking has been the technology of choice for aircrafts for more than 60 years. Brakes integrated into aircraft wheels include stacks of rotors integrally rotatable with the wheel, and stators that pinch the rotors. The steel making up the discs has gradually been replaced by C—C composite materials, which offer lower densities and superior friction performance at the high temperatures generated during braking.

The manufacture of such disks usually comprises a step of producing a fibrous preform made of carbon fibers having a shape close to that of a disk to be manufactured, and intended to constitute the fibrous reinforcement of the composite material, and a step of densifying the preform with a matrix made of pyrolytic carbon (PyC) to form a blank. A well-known method for producing a fibrous preform made of carbon fibers comprises superimposing fibrous strata made of carbon precursor fibers, for example made of pre-oxidized polyacrylonitrile (PAN), bonding the strata together, for example by needling, and carrying out a carbonization heat treatment to convert the precursor into carbon. Reference can be made, inter alia, to U.S. Pat. No. 5,792,715.

Densification of the blank with a PyC matrix can be carried out by chemical vapour infiltration (CVI). Blanks are placed in an enclosure into which is introduced a gaseous phase containing one or more carbon precursors, such as methane and/or propane. Temperature and pressure in the enclosure are controlled to allow the gaseous phase to diffuse within the preforms and to form therein a solid deposit of pyrolytic carbon by decomposition of the precursor(s). A method for densifying a plurality of annular brake disk preforms arranged in stacks is described, inter alia, in U.S. Pat. No. 5,904,957.

Densification with a carbon matrix can also be carried out by liquid route, i.e. by impregnating the preform with a carbon precursor, typically a resin, and pyrolyzing the precursor, several impregnation and pyrolysis cycles being usually carried out.

A so-called “calefaction” densification method is also known, whereby a disk preform to be densified is immersed in a bath of carbon precursor, e.g. toluene, and heated, e.g. by coupling with an inductor, so that the precursor vaporized on contact with the preform diffuses within it to form a PyC deposit by decomposition. Such a method is described inter alia in U.S. Pat. No. 5,389,152.

Among the various desired properties of brake discs based on C/C composite material, low wear is highly desirable. To improve wear resistance, the introduction of ceramic grains into the C/C composite material has been widely proposed. Thus, U.S. Pat. No. 6,376,431 describes the impregnation of a carbon fiber blank with a sol-gel type solution containing a silica precursor (SiO₂) which, after heat treatment and chemical reaction with carbon, leaves silicon carbide (SiC) grains distributed in the blank, these grains representing no more than 1% by weight in the final C/C composite material.

WO 2006/067184 recommends carrying out an impregnation with a sol-gel type solution or a colloidal suspension on the fibrous texture of the strata used to produce the blank, in order to obtain a dispersion of grains of oxides such as titanium (TiO₂), zirconium (ZrO₂), hafnium (HfO₂) and silicon (SiO₂) oxides. Subsequent heat treatment transforms these oxide grains into carbide grains. EP 1 748 036 describes impregnation of a carbon fiber substrate with a slurry containing a carbon precursor resin and metal oxide grains, e.g. SiO₂, TiO₂, ZrO₂, . . . . After heat treatment, a C/C composite material is obtained containing carbide grains obtained by transformation of oxide particles. The examples show the use of oxide grains of several microns in size. EP 0 507 564 describes the production of a part made of C/C composite material by mixing carbon fibers, ceramic powder and carbon powder, molding and sintering, the ceramic powder being, for example, an oxide such as SiO₂, TiO₂, ZrO₂, or a nitride. The use of ZrO₂ powder made of one-micron grains is mentioned in Example 2, the amount of ZrO₂ in the final composite material being 6.2%. It should be noted that, among the ceramic powders considered, ZrO₂ is far from giving the best wear results. EP 0 404 571 describes a method similar to that of EP 0 507 564, but for forming a low-friction sliding part.

In particular, methods are known for manufacturing parts with improved properties, comprising adding ceramic fillers within a carbon blank made of carbon/carbon (C/C) composite, wherein fillers are introduced via an impregnation-drying method with a sol containing the ceramic particles. The method is described in patent application FR 2 945 529. Such a method makes it possible to obtain improved mechanical properties, which is of particular interest for parts based on C/C composite material, whatever their purpose.

However, when implementing these methods, it is very difficult to achieve a homogeneous distribution of particles within the blank, resulting in a filler gradient across the thickness of the material. These fillers are typically distributed as follows for a part, for example a friction part: a large quantity of fillers is present in the vicinity of the faces, for example the friction faces, whereas only a reduced quantity of fillers is present being introduced into the core of the blank.

This atypical distribution of fillers generates risks related, among other things, to the variability of tribological properties during the service life of the part, for example depending on its wear level, a wear of some faces may be observed. In the case of a friction part, for example, wear on the friction faces of the order of several millimeters can be observed during the life of the brake.

For C—C materials incorporating ceramic particles, it is essential to properly control the dispersion of the particles within the part. On new parts, for example discs, a gradient in the distribution of ceramic particles, such that there is a greater quantity of particles on the faces compared to the core of the part, will generate a significant variability in tribological properties such as wear and braking performance, i.e. a variation in the coefficient of friction, during the life of the disc. Furthermore, these methods are subject to time and cost constraints associated with their industrial manufacturing. Parts must indeed be produced at high production rates.

### DISCLOSURE OF THE INVENTION

The invention thus aims in particular to solve the problems of filler distribution within a part whose manufacture comprises addition of ceramic fillers within a carbon blank made of carbon/carbon (C/C) composite in the context of an industrial manufacturing process, and of treatment variability from one blank to another during the implementation of the process. The invention aims to reduce the risk of variability in the tribological properties of such parts over their service life, while enabling industrial production rates.

To this end, a diffuser is proposed for diffusing a gas flow within a stack of blanks of parts based on carbon/carbon composite impregnated with a sol-gel type solution, the solution including a solvent and one or more compounds, the gas flow enabling the solvent to be evaporated by heat transfer, each blank having a central through hole, the central holes passing through the blanks of the stack by forming a central well of the stack, the diffuser including a plurality of diffusion vanes each including a central end and a peripheral end, the vanes extending from a central cavity of the diffuser to the periphery of the diffuser,
each vane having a central through opening, the central through openings of the vanes forming the open central cavity of the diffuser, so as to form a gas inlet open upwards when the diffuser is installed so as to be associated with the stack, the section of the central cavity decreasing from the gas inlet,
said vanes being adapted to extend at least partially into the central well when the diffuser is installed so as to be associated with the stack, the vanes being adapted to diffuse and homogenize over the entire height of the stack the gas flow flowing from the central well through the stack.

The device may include the following features, taken alone or in any of their technically possible combinations:
the vanes each include an inclined section extending between the central end and the peripheral end, the peripheral diameter of the vanes being constant, for example,
the diffuser is configured so that, when the diffuser is installed so as to be associated with the stack, the peripheral end of each vane faces an internal wall of a blank, so that the gas flow is directed towards the periphery between the blanks,
a deflector adapted to extend at least partially above the stack when the diffuser is installed so as to be associated with the stack, in order to guide the gas towards the central well of the stack, for example towards the central cavity of the diffuser,
   one or more structural element(s) connecting the vanes to each other and, for example, to the deflector, the structural elements including, for example, a plurality of rods.

A diffusion assembly is proposed including:
such a diffuser, and
a base configured so that the diffuser rests on the base when installed so as to be associated with the stack.

A stack assembly is proposed including:
such a diffuser or diffusion assembly, and
blanks of parts based on carbon/carbon composite impregnated with a sol-gel type solution, the solution including a solvent and one or more compounds, the blanks being arranged in a stack, each blank having a central through hole, the central holes passing through the blanks of the stack forming a central well of the stack,
   the diffuser being installed so as to be associated with the stack.

### BRIEF DESCRIPTION OF THE DRAWINGS

Other features, purposes and advantages of the invention will become apparent from the following description, which is purely illustrative and non-limiting, and which should be read in conjunction with the appended drawings in which:

FIG. 1 schematically illustrates a drying assembly and a device according to an example of embodiment of the invention.

FIG. 2 schematically illustrates two subsets of drying chambers of a device according to an example of embodiment of the invention.

FIG. 3 schematically illustrates a stack assembly, a diffusion assembly and a diffuser according to another example of embodiment of the invention.

FIG. 4a schematically illustrates a sectional view of a stack assembly, a diffusion assembly and a diffuser of FIG. 3.

FIG. 4b schematically illustrates a detail of FIG. 4a.

FIG. 4c schematically illustrates a perspective view with partial section of the stack assembly, the diffusion assembly and the diffuser of FIG. 3.

FIG. 5 schematically illustrates a sectional view of the diffuser shown in FIG. 3.

FIG. 6 schematically illustrates a system according to an example of embodiment of the invention.

FIG. 7 is a flowchart of steps of a drying process according to an example of embodiment of the invention.

FIG. 8 is a flowchart of steps of a manufacturing process according to an example of embodiment of the invention.

Throughout the figures, similar elements have identical references.

### DETAILED DESCRIPTION OF EMBODIMENTS

### General Description

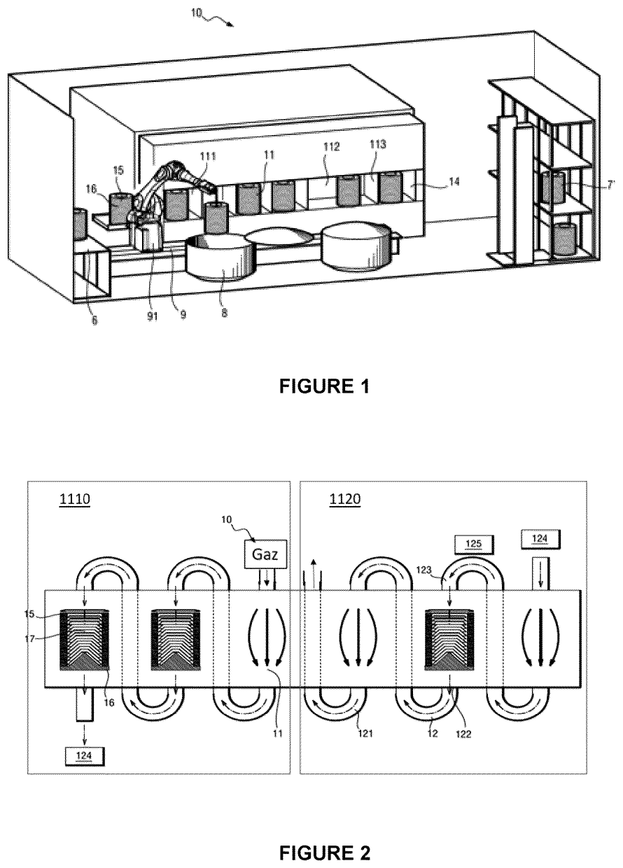

Referring to FIGS. 1 and 2, a device (10) for drying blanks (15) of parts based on carbon/carbon composite material impregnated with a sol-gel type solution is described. The solution includes a solvent and one or more compounds.

The system 10 may include a set of chambers 11 for drying the blanks. The drying chambers 11 can be arranged to receive the blanks 15 successively along the circulation direction of the blanks. The set may include a subset of drying chambers 11.

The drying chambers 11 can be configured so that several of the chambers 11 in the set or subset have different drying process parameters relative to one another.

The set of drying chambers 11 may include one or more solution gelling chamber(s) 111 in order to form a gel. The plurality of drying chambers 11 may include one or more evaporation chamber(s) 112 for evaporating the solvent present within the gel, for example the formed gel. The evaporation chamber(s) 112 may be arranged downstream of the gelling chamber(s) 111 in the circulation direction.

The subset of drying chambers 11 may include at least several of the gelling chambers 111 or several evaporation chambers 11 of the set of drying chambers 11, for example only some gelling chambers 11 or some evaporation chambers 11, or for example all the gelling chambers 11 or all the evaporation chambers 11 of the set. FIG. 2 illustrates a subset 1110 of gelling chambers and a subset 1120 of evaporation chambers. By subset of drying chambers is meant in this context a subset of chambers of the same type, either a subset 1110 of gelling chambers or a subset 1120 of evaporation chambers.

The system may include a tunnel. By tunnel is meant a structure longer than high, through which the stacks move. The tunnel may include all the drying chambers 11. The drying chambers 11 of the set can thus participate in forming the tunnel.

The system may include gas circulation means 12 configured to allow the circulation of a drying gas between the chambers 11 of the subset of chambers 11. Within the subset of chambers 11, the gas circulation means 12 may thus be configured to allow circulation of drying gas from one chamber 11 of the subset to another chamber 11 of the subset.

It has been identified that the filler gradient in the thickness of the material within the blank in the prior art was mainly caused by the sets of parameters applied during the drying step. As ceramic precursor macromolecules are nano-sized, there is a risk that they will be conveyed by the solvent as it evaporates. In fact, in the prior art, particles present in the core will partially migrate towards the periphery of the disc, via a conveying phenomenon in a porous medium.

The arrangement of the device with such a subset of chambers makes it possible to change the parameters from one chamber to another, and thus obtain optimized blank drying conditions.

The configuration of the device makes it possible to implement industrial drying means that do not have the disadvantages of the prior art in terms of filler gradients, while allowing drying of many parts, by operating according to a flow, for example continuously. It is thus possible to define an industrial facility with production capacities far superior to those of an integral processing of stacks of blanks one after the other, the facility thus being able to produce large quantities of parts with an optimized cycle time, respecting the optimal drying parameter specification for the processed blanks, for example in terms of temperature, environmental humidity, and duration.

Such a device has a space requirement compatible with the space available in existing installations for processing blanks.

Such a device also makes it possible to reduce the quantities of sol-gel type solution used.

### Circulation Means

The gas circulation means 12 can be configured to circulate the gas between the chambers 11 in the subset of drying chambers 11 in the opposite direction to the direction of circulation, so that the solvent content of the gas within the chambers 11 of the subset decreases or is equal from one chamber 11 to another in the direction of circulation of the blanks. This enables gas use and solvent uptake to be optimized.

The gas circulation means 12 may include gas circulation sections 121 between successive chambers 11. For example, the sections 121 include, between each pair of successive chambers 11 of the chamber subset, a dedicated section 121 fluidly connecting the two successive chambers.

It is thus possible to optimize drying while using gas flows that are compatible with existing installations.

One or more of the drying chambers 11 in the assembly may include a gas outlet 122 and/or a gas inlet 123.

For the first chamber 11 of the subset in the direction of circulation, the outlet 122 may allow gas to be extracted from the subset of chambers 11, for example in order to regenerate it, and reintroduced at the inlet 123 of the last chamber 11 of the subset in the direction of circulation.

The device 10 may include gas desaturation means 124. The gas desaturation means 124 may be configured to allow at least partial solvent desaturation of gas, for example gas from the chamber subset, for example from the outlet 122 of the first chamber 11 of the subset in the direction of circulation. The desaturation means 124 can, for example, be selectively activated or deactivated.

For chambers 11 of the subset that are posterior to the first chamber 11 of the subset in the direction of circulation, the outlet 122 may be used to connect the posterior chamber 11 of the subset with the section 121 connecting the same chamber 11 with the chamber 11 of the subset immediately prior in the direction of circulation. For chambers 11 of the subset which are anterior to the last chamber 11 of the subset of chambers in the direction of circulation, inlet 123 can be used to connect each anterior chamber 11 with the section 121 connecting the same chamber with the chamber of the subset immediately posterior in the direction of circulation.

For the last drying chamber 11 of the subset in the direction of circulation, inlet 123 can be used to introduce the drying gas into the subset of drying chambers 11. Nitrogen in the last drying chamber 11 of the subset thus contains the cleanest drying gas and allows elimination of most solvent, since each drying chamber 11 of the subset contains a cleaner drying gas and has a greater solvent removal capacity than the previous drying chamber 11 in the direction of circulation of the blanks.

The drying gas can thus be circulated through the chambers of the subset in the opposite direction to the direction of circulation of the blanks, its solvent content increasing as it circulates, for example until a solvent-saturated drying gas is obtained.

The inlet 123, for the last drying chamber 11 of the subset in the direction of circulation, that can be used to introduce the drying gas, may be in fluid communication with drying gas mixing means that may be used to provide a mixed drying gas to the inlet 123. The mixing means may include a gas mixer. The mixing means can be configured to mix a solvent-free drying gas with a drying gas having a non-zero solvent content, e.g. greater than 50%, e.g. less than 90%, e.g. about 75%. The solvent-free, e.g. completely desaturated or clean, drying gas can come from a clean gas tank. Drying gas with a non-zero solvent content can come from another corresponding gas tank or directly from the drying circuit.

The gas circulation means 12 can be configured to circulate the drying gas between the chambers 11 of the subset at a speed of between 10 and 50 cm/sec, for example between 20 and 40 cm/sec, for example 30 cm/sec. The gas circulation means 12 can be configured to circulate the drying gas between the chambers 11 of the subset at a flow rate of between 200 and 600 Nm³/h, for example between 300 and 500 Nm³/h, for example 390 Nm³/h.

In addition to circulating gas between the chambers 11 of the subset of drying chambers, the gas circulation means 12 may include gas circulation means dedicated to each of another or other chamber(s) of the drying chambers 11 of the set not belonging to the subset, for example for one or more gelling chamber(s), the dedicated gas circulation means being configured to circulate a drying gas in the corresponding drying chamber, for example without necessarily circulating the gas between this chamber and the other drying chambers. Thus, for such another chamber 11, the inlet 123 may allow the drying gas to be introduced, the drying gas forming for example a gelling gas, e.g. a solvent-saturated gas, for example from a tank, e.g. the solvent-saturated gas tank described above. Alternatively, the subset may include the gelling chamber(s), in which case the gas flowing between the chambers of the subset therefore circulates notably in this way into the gelling chamber(s).

The circulation means therefore allow the gas to circulate through each chamber of the subset, increasing its humidity, i.e. its solvent content, until a maximum humidity is reached in the gelling chambers, compared with the minimum in the drying chambers.

The device 10 may also include gas heating means 125. The circulation means 12 may include the heating means 125. The heating means 125 may be configured to heat the gas at least at some of the circulation sections 121. The heating means may include a heating system, and the heating system may include one or more heating unit(s), each heating unit being for example dedicated to one of the circulation sections 121. The heating means 125 include resistors for example. It is thus possible to regulate the temperature of the gas between the chambers of the subset. It is also possible to avoid having to heat the walls of the tunnel.

The circulation means 12 can be controlled, for example activated or deactivated.

The drying gas may be or include an inert gas. The gas may be or include nitrogen.

### Chambers

The device 10 can be configured so that the gas entering each of the evaporation chamber(s) 112 has a temperature higher than the temperature of the gas at the inlet to each of the gelling chamber(s) 111, which is typically 85° C. Such a temperature difference allows to reduce the duration of the process. For example, the target temperature of the gas at the inlet of the evaporation chamber(s) may be 110° C.

The device 10 can be configured so that, when passing through the gelling chamber(s) 111, the temperature of the blanks increases progressively. Once gelling is complete after passing through the gelling chamber(s) 111, the blanks undergo evaporation of the solvent by means of the drying gas flow, so that the solvent content within the blanks 15 decreases as the blanks 15 advance through the tunnel.

The tunnel configuration with successive chambers allows to optimise the implementation of gelling and then evaporation sequentially. It is thus possible to limit any excessive evaporation, for example greater than 5% of the total sol-gel content of the preform, of the solvent before evaporation. It is thus possible to control and limit the filler gradient within the blanks.

The gas entering each of the gelling chamber(s) 111 and/or a temperature set point within the gelling chamber(s) 111 may be at a temperature of between 7° and 100° C., for example between 8° and 90° C., for example 85° C. The gas at the inlet of each of the evaporation chamber(s) 112 and/or a temperature set point within the evaporation chamber(s) may be at a temperature of between 9° and 130° C., for example between 10° and 120° C., for example 110° C.

The device 10 may include from one to 8 gelling chamber(s) 111, for example at least 2 and/or at most 6 gelling chambers 111, for example 4 gelling chambers 111. The device 10 may include from 5 to 17 evaporation chamber(s) 112, for example at least 7 and/or at most 14 evaporation chambers 112, for example 11 evaporation chambers 112.

The device 10 can be configured so that the gas entering each of the gelling chamber(s) 111 is saturated with solvent. This ensures an optimised gelling by limiting the generation of a filler gradient within the thickness of the blank 15.

The tunnel may also include one or more blank cooling chamber(s) 14 arranged downstream of the set of blank drying chambers 11 in the direction of circulation. For one or more of the cooling chamber(s) 14, the cooling may be natural cooling or gas-accelerated cooling. In the latter case, the cooling chamber(s) may include an inlet 123 and an outlet 122 as described above. It is thus possible that the blanks reach room temperature, for example.

The tunnel can be a continuous drying tunnel including all the drying chambers 11 and, where appropriate, one or more cooling chamber(s) 14. The device may thus include more than 5 drying chambers, for example more than 10 drying chambers.

The tunnel may include an inlet door and an outlet door and doors 113 between successive drying chambers 11 and/or successive cooling chamber(s). The doors 113 are adapted to allow the passage of the blanks 15, for example arranged in stacks 16, from one chamber to another. For example, for each pair of successive chambers 11 and/or 14, one of the doors 113 extends between the two successive chambers. The doors 113 can each be selectively opened or closed, for example according to a command from control means as described below.

The drying chambers 11 of the subset, or the drying chambers of the set, and/or the cooling chamber(s) 14, have for example a surface area of between 0.2 and 1 m², for example between 0.3 and 0.5 m², for example a length of between 0.4 and 1 m, for example 0.6 m, and a width of between 0.4 and 1 m, for example 0.6 m.

### Continuous Circulation

The device 10 may be adapted to continuously move forward the blanks 15 through the plurality of drying chambers 11 in the direction of circulation. The device 10 may include a belt on which the blanks 15 are arranged, the belt being adapted to continuously move forward the blanks 15, for example at constant flow.

Facilities incorporating the device are thus able to dry numerous parts. Continuous drying, for example at a constant flow, allows to offer industrial manufacturing times and costs ensuring high production rates.

Transit time of a blank 15 through one or more of the drying chambers, for example each drying chamber 11, can be between 30 min and 1 h30, for example between 45 min and 1 h15, for example 60 min.

### Part Blank and Part

The part blank is for example disc-shaped. The blank, for example the disc, has for example a central through hole 151.

The part blank is for example a friction part blank, for example a brake disc, for example an aircraft brake disc, or a part for another application and/or another part made of C/C composite material, for example a brake disc for land vehicles, for example cars, for example a racing car, and friction parts other than discs, in particular pads.

The part is thus for example a friction part, for example a brake disc, for example an aircraft brake disc, or a part for another application and/or another part made of C/C composite material.

The part blank may be a fibrous blank, for example made of carbon fiber. The part blank may be configured to constitute a fibrous reinforcement of a composite material of the part.

The part blank may include a superposition of fibrous strata, the fibrous strata being for example bonded together, for example by needling. The part blank may be obtained by a blank obtaining step as described below.

### Sol/Gel Type Solution

The solution may include a solvent and one or more compounds.

The solvent may include or be an alcohol-based solvent. The solvent may include or be butanol and/or ethanol, for example a mixture of butanol and ethanol.

The compound(s) may be or include one or more precursor(s), for example ceramic precursor(s), for example silica (SiO₂), and/or titanium oxide (TiO₂), and/or zirconium oxide (ZrO₂), and/or hafnium oxide (HfO₂) precursor(s). It will thus be possible to form grains of silicon carbide (SiC) and/or titanium carbide and/or zirconium carbide and/or hafnium carbide, distributed in the blank.

The solution may further include a chelating agent, allowing to control gelling kinetics for example.

The solution may include a hydrolysis agent, for example water.

### System

Referring to FIG. 6, a system 1 is described for impregnating blanks of parts based on carbon/carbon composite material with the sol-gel type solution so as to obtain the blanks 15 and for drying the impregnated blanks 15.

The system 1 may include obtention means 6, for example a unit for obtaining a blank of part based on carbon/carbon composite material. The obtention unit may be or include a blank manufacturing unit. The obtaining means 6 may be adapted to deliver the blanks obtained arranged in blank stacks as described below.

The system 1 may include an input storage area 7. The input storage area forms a space suitable for storing part blanks, for example obtained part blanks. The blanks may be stored arranged in blank stacks 16 as described below. The input storage area 7 may be adapted to store a plurality of stacks 16, for example several dozens of stacks, for example more than 70 stacks.

The system 1 includes means 8 for impregnating blanks, for example blanks arranged in stacks, to obtain impregnated blanks 15. The impregnation means 8 may include at least one impregnation device 8, for example one or more impregnator(s). Each impregnator may be adapted to receive and impregnate blanks from a stack 16 simultaneously.

The system may include an intermediate storage area 9. The intermediate storage area 9 forms a space suitable for storing the impregnated blanks 15. The blanks 15 may be stored arranged in blank stacks 16 as described below. The intermediate storage area 9 may be adapted to store a plurality of stacks 16 of impregnated blanks. The intermediate storage area 9 may include means 91 for automated installation of diffusers 17 as described below.

The system 1 includes the device 10 for drying the impregnated blanks.

The system 1 may include an output storage area 7′. The output storage area forms a space suitable for storing the part blanks after drying by the device 10, for example stored in stacks. The output storage area 7′ can be adapted to store a plurality of stacks 16, for example several dozens of stacks, for example more than 70 stacks.

The system 1 may be compact in size. For example, the system may be contained in an area with a length of between 9 and 13 m, for example between 10 and 12 m, for example 11.3 m, and a width of between 2 and 6 m, for example between 3 and 5 m, for example 4.3 m.

The system 1 can form a closed and sealed room. Elements such as the obtaining means 6 and/or the inlet storage area 7 and/or the impregnation means 8 and/or the intermediate area 9 and/or the device 10 and/or the outlet storage area 7′ can be arranged within the closed and sealed room. It is thus possible to obtain a closed and sealed system 1 occupying an optimised space.

The system may be an automated system. For example, the system may be such that all the manipulations carried out within the system by the obtaining means 6 and/or the input storage area 7 and/or the impregnation means 8 and/or the intermediate area 9 and/or the device 10 and/or the output storage area 7′ and/or between these elements may be automated. To do this, the system may include one or more robots and/or conveyor(s) and/or stacker crane(s). It is thus possible to limit any human intervention and thereby limit any risk of contamination during drying.

### Stack(s)

The device 10 or system 1 may be such that the preforms and/or blanks are arranged in stack(s) 16. Each stack 16 may include a plurality of preforms or blanks 15, for example a number of preforms or blanks greater than 10 or less than 20, for example 15. The stack 16 may include one or more wedges 162 arranged between preforms or blanks in the same stack. The wedges 162 may be arranged so that the preforms or blanks 15 in the same stack 16 are separated in pairs by one of the wedges 162. Each wedge 162 may have a thickness greater than 2 mm, for example greater than 3 mm, and/or less than 10 mm, for example less than 6 mm.

### Diffuser(s)

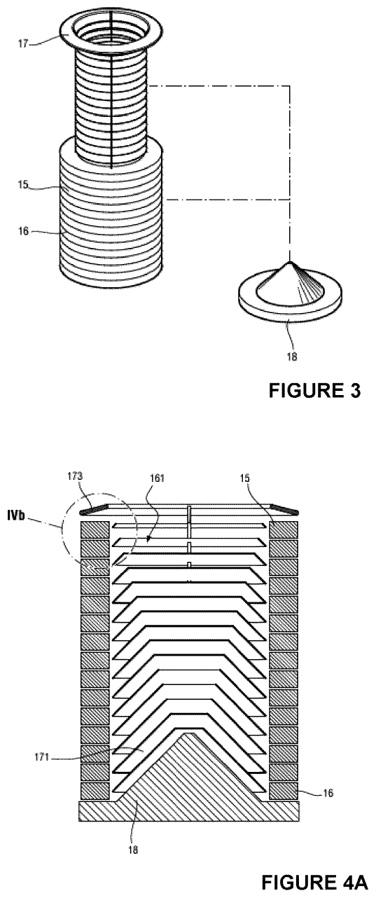

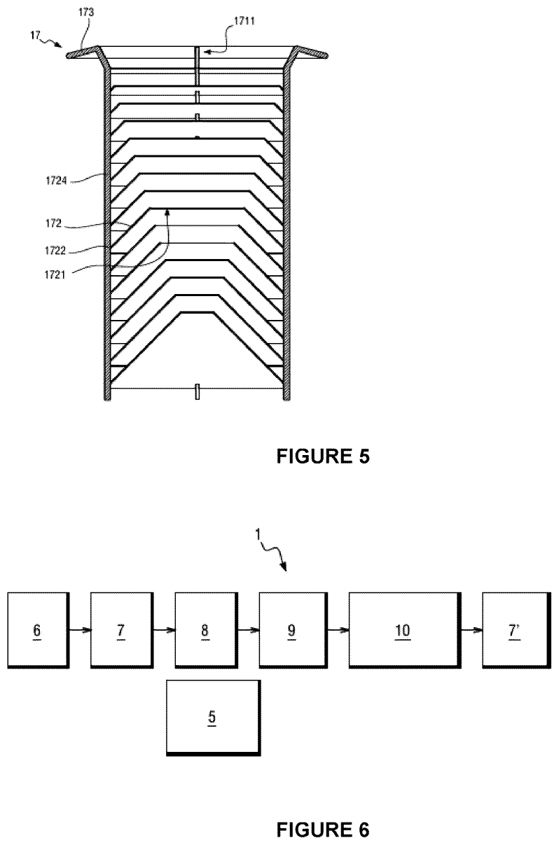

Referring to FIGS. 3, 4a to 4c and 5, a diffuser 17 is described for diffusing a gas flow within the stack 16 of part blanks 15, the gas flow allowing the solvent to be evaporated by heat transfer. Each blank 15 has a central port 151 therethrough, the central ports 151 passing through the blanks 15 of the stack 16 forming a central well 161 of the stack 16.

The diffuser 17 includes a plurality of diffusion vanes 172. The vanes 172 are adapted to extend at least partially into the central well 161 when the diffuser 17 is installed, for example installed so as to be associated with the stack, the vanes 172 being adapted to diffuse and homogenise over the entire height of the stack 16 the gas flow flowing from the central well 161 through the stack.

Each diffuser 17 is adapted to be received or to extend at least partially within the stack 16, so as to diffuse a gas flow through the stack and to homogenise the drying of the blanks in the stack 16. The diffuser 17 is thus adapted to distribute the drying gas and homogenise the temperature of the blanks 15 in the stack 16. The device 10 or system 1 may include diffusers 17.

By height is meant, for example, the dimension defined by the vertical direction in a laboratory frame of reference when the device or diffuser or diffusion assembly or stack assembly, or any other element of the system, is in the position of use, and/or is meant according to the direction defined by gravity.

By “bottom”, respectively “top” is meant downwards, respectively upwards in a laboratory frame of reference when the device or diffuser or diffusion assembly or stack assembly, or any element of the system, is in the position of use, and/or is meant according to the direction defined by gravity, respectively a direction opposite to gravity.

By “below” respectively “above” is meant downwards or upwards, respectively, in a laboratory frame of reference when the device or diffuser or diffusion assembly or stack assembly, or any element of the system, is in the position of use, and/or is meant according to the direction defined by gravity, respectively a direction opposite to gravity.

By “lower”, respectively “upper” is meant downwards or upwards, respectively, in a laboratory frame of reference when the device or diffuser or diffusion assembly or stack assembly, or any element of the system, is in the position of use, and/or is meant according to the direction defined by gravity, respectively a direction opposite to gravity.

In order to respect the drying cycle and to avoid any excessively high temperature on the parts, the internal heat transfer in the blank is carried out mainly or solely by conduction thanks to the gas flow and the diffuser 17, allowing to guide the gas flow through the stack 16 of blanks. Drying can be carried out without supply of thermal radiation energy, such as heating the wall of the device 10.

The diffuser 17 allows to prevent the gas flow from moving to the top of the stack first, and that only a small amount of heat from the gas would be transferred to the top blank, increasing its temperature and reducing the temperature of the gas flow. This process would proceed gradually to the lowest blank, which would receive much less energy due to a lower gas temperature. Therefore, the heating process would be much slower in the lower part of the stack than in the upper part. The diffuser 17 thus allows to avoid a too large difference in temperature between the blank 15 at the top and the blank 15 at the bottom of the stack 16, a difference which would increase the time required for heating and which could generate in the same stack 16 the simultaneous presence of blanks, for example discs, in different states of the heating cycle, for example that is to say blanks 15 at the top of the stack 16 having reached the gelling or even evaporation temperature while the blanks 15 at the bottom of the stack 16 would still be at a temperature below that of gelling. The diffuser 17 has a geometry that depends on the dimensions of the blanks 15 to be dried and of the stack, particularly the thickness of each blank and the number of stacked blanks. The diffuser 17, by guiding the gas flow through the blanks, and by increasing or reducing the gas flow, homogenises the heating process on the height of the stack 16.

The diffuser 17 allows the temperature of the blanks 15 in the stack to increase gradually and uniformly relative to each another, in particular between the blanks at the top and the blanks at the bottom of the stack 16.

Use of such a diffuser 17 is particularly advantageous when the gas flow has a low speed and/or when the drying comprises successive steps of gelling and evaporation of the solvent.

The diffuser may have a central cavity 171. The vanes 172 may each include a central end 1722 and a peripheral end 1723, the vanes extending from the central cavity 171 of the diffuser 17 towards the periphery of the diffuser 17. The central end 1722 may form a central edge or inner edge of the vane 172. The peripheral end 1723 may form a peripheral edge or outer edge of the vane 172.

Each vane 172 may have a central through opening 1721. The central through openings 1721 of the vanes may form the central cavity 171 of the diffuser 17. The central cavity 171 may be open so as to form an gas inlet 1711 open upwardly when the diffuser 17 is installed so as to be associated with the stack 16, the sectional area of the central cavity decreasing from the gas inlet. The minimum section of the central cavity may correspond to the diameter of the central opening 1721 of the lowest vane 172, which may be between 60 and 100 mm, for example 70 mm.

The vanes 172 may each include a section 1724 extending between the central end 1722 and the peripheral end 1723. The section 1724 may be an inclined section. The inclination is, for example, such that the peripheral end 1723 of each inclined vane 172 is lower than the central end 1723 of the same vane 172. The inclination may be between 30° and 60° to the horizontal, for example between 40° and 50° to the vertical, for example 45°.

The vanes 172 may be rotationally symmetrical about the central opening 1721, and for example about the central cavity 171.

The peripheral diameter of the vanes may be constant. In the case of an inclined section 1724 with a central cavity of decreasing section, it is possible to optimise the gas flow in order to homogenize the flow passing through the stack 16 over its height.

The diffuser 17 can be configured so that, when the diffuser 17 is installed so as to be associated with the stack 16, the peripheral end 1723 of each vane 172 faces an internal wall 152 of a blank 15 so that the gas flow is directed towards the periphery between the blanks 15. The stack 16 and the diffuser 17 may be such that, for each blank 15 in the stack, one of the diffuser vanes 172 faces an internal wall 152 of said blank 15. The vanes 172 of the diffuser 17 can be such that each vane corresponds to each blank 15 in the stack. It is thus possible to guide the gas flow in a plurality of flows, each directed between two successive blanks 15 of the stack 16. It is indeed between the blanks that the gas can flow and fully dry each blank 15. This can be facilitated by separating the blanks two by two by the wedges 162. The vanes 172 may be evenly spaced, for example 40 mm apart. In particular, the diffuser 17 may be configured so that, when the diffuser 17 is installed so as to be associated with the stack 16, the peripheral end 1723 of each vane 172 extends halfway up the inner wall 152 of a blank 15 so that the gas flow is directed towards the periphery between the blanks 15.

The diffuser may include a deflector 173. The deflector may be adapted to extend at least partially above the stack 16 when the diffuser 17 is installed, for example installed so as to be associated with the stack, in order to guide the gas towards the central well 161 of the stack 16, for example towards the central cavity 171 of the diffuser. The deflector 173 may have an annular shape. The deflector may be adapted to cover the blanks 15 of the stack 16. The deflector 173 may form the head of the diffuser 17.

The deflector may include an inclined section, for example so that a peripheral end of the deflector is lower than a central end of the deflector. This makes it possible to guide part of the gas flow over the uppermost part of the blank 15, while reducing the flow so as to avoid overheating the upper part of the blank 15.

The diffuser 17 may include one or more structural elements 174 connecting the vanes 172 together, and for example with the deflector 173. This makes it possible to hold the vanes 172 in place while minimising the impact on the flow. The structural elements include, for example, a plurality of rods, for example extending vertically when the diffuser 17 is installed.

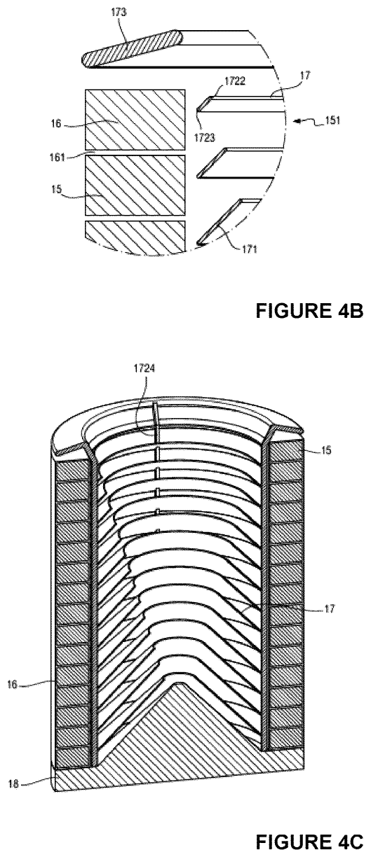

Referring to FIG. 3 and FIGS. 4a to 4c, a diffuser assembly is described including the diffuser 17, and a base 18 configured so that the diffuser sits on the base when installed so as to be associated with the stack 16. The base 18 may also form a support for the stack 16. Upon formation, the stack 16 may be formed on the base 18. The base 18 may include a blank support portion, including for example a peripheral annular surface, for example planar, configured to support the stack 16. The base may include a diffuser support portion, including for example an inclined portion, for example conical or frustoconical, configured to support the diffuser 17, for example lower ends of the structural elements 174.

Referring to FIG. 3 and FIGS. 4a to 4c, a stack assembly is described including the diffuser 17 or diffuser assembly, and the blanks 15 arranged in stacks 16, the diffuser 17 being installed so as to be associated with the stack 16. The diffuser 17 may be dimensioned so as to be spaced from the stack 16, for example so that the peripheral end 1723 of each vane 172 is spaced from the inner wall of the blanks 15 facing said peripheral end 1723. This allows the diffuser 17 to be easily positioned and removed.

The diffuser 17 may be or include a metallic material. The diffuser 17 may be produced by mechanically welding, for example by mechanically welding the vanes 172 and the structural elements 174, and for example the deflector 173. The diffuser 17 may be produced by additive manufacturing.

The device 10 or system 1 may further include means 91 for automated installation of the diffusers within the stacks, for example a unit for automated installation of the diffusers 17 within the stacks 16. The automated installation means may include an automated installation device 91. The automated installation device 91 may include a robotic arm.

### Drying Assembly

Referring to FIGS. 1 and 2, a drying assembly is described. The drying assembly includes the drying device 10 or the impregnation system 1. The drying assembly further includes the preforms and/or blanks 15, the preforms and/or blanks 15 being arranged in stacks 16, for example.

The drying assembly may include the blanks obtained by the production means 7, and/or the blanks stored in the storage area 7.

### Control Means

The device 10 or assembly 1 may include control means 5, for example a control system including one or more control uni(t)s, the control means 5 including data processing means configured to carry out the drying process and/or manufacturing process as described below. The data processing means may include one or more data processing unit(s). The data processing means and/or the data processing unit(s) may include one or more processors.

The control means 5 may, for example, implement temperature control, for example for the temperature measured at a first temperature sensor and/or a second temperature sensor. The control means 5 may, for example, implement humidity control, for example for the humidity measured at a first temperature sensor and/or a second temperature sensor.

### Drying Process

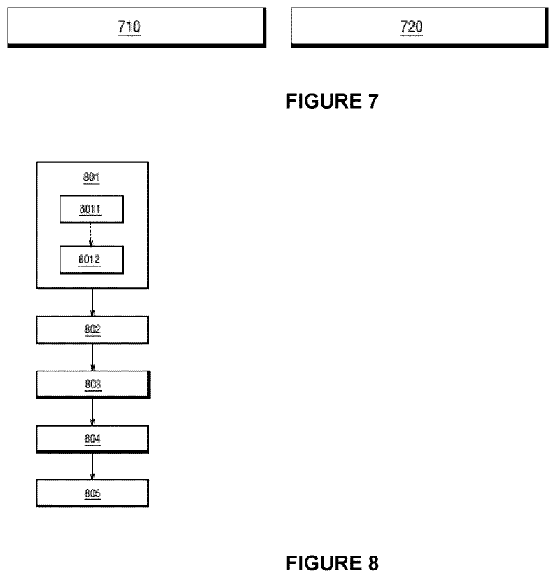

Referring to FIG. 7, a process is described for drying blanks 15 of parts based on carbon/carbon composite material carbon/carbon; impregnated with the sol-gel type solution, the solution including the solvent and the compound(s). The process is carried out using device 10 or system 1. The process may comprise circulating 710 the blanks 15 in the drying chambers 11 in the direction of circulation of the blanks. The process may comprise, simultaneously with the circulation of the blanks, circulating 720 the drying gas between the chambers 11 of the plurality of chambers. The process may further comprise recovering the drying gas having a non-zero solvent content, for use in the gelling step.

### Manufacturing Process

Referring to FIG. 8, a process is described for manufacturing a part, for example the part, based on a carbon/carbon composite material. The manufacturing process may be carried out continuously. The process may be carried out by using the device 10 or system 1 or drying assembly.

The manufacturing process may comprise a step 801 of providing or obtaining blanks 15 of parts based on carbon/carbon composite material, for example blanks 15, for example within the assembly 1. The part blanks 15 may be positioned in a stack.

The providing or obtaining step 801 may comprise a sub-step 8011 of providing or obtaining preforms of a part based on carbon/carbon composite material, for example by the obtaining means 6. The step 8011 of providing or obtaining preforms may comprise arranging the preforms in stacks of preforms. The sub-step 8011 of providing or obtaining preforms may include, for each preform, superposing fibrous strata, for example of carbon precursor fiber, for example of pre-oxidised polyacrylonitrile (PAN). The providing or obtaining sub-step 8011 may comprise, for each preform, bonding the fibrous strata together, for example by needling. The sub-step 8011 of providing or obtaining preforms may comprise, for example after bonding of the fibrous strata, a carbonisation heat treatment to convert the carbon precursor into carbon.

The providing or obtaining step 801 may comprise, for example subsequent to the sub-step 8011 of providing or obtaining preforms, a sub-step 8012 of densifying the preforms produced, for example with a die, for example a pyrolytic carbon (PyC) die, so as to transform the preform into the blank.

The densification sub-step 8012 can be carried out by chemical vapour infiltration (CVI). During the sub-step 8012 of densifying by chemical infiltration, the preforms can be placed in an enclosure, into which a gaseous phase containing one or more carbon precursors, for example methane and/or propane, is entered. Temperature and pressure in the enclosure can be controlled to allow the gaseous phase to diffuse into the preforms and form therein a solid deposit of pyrolytic carbon by decomposition of the precursor(s). During the densification sub-step 8012, the preforms can be arranged in stacks.

Alternatively, the densification sub-step 8012 may be carried out by liquid means. The densification sub-step 8012 may comprise impregnation of the preforms with a carbon precursor, for example a resin. After impregnation, the densification sub-step 8012 may comprise pyrolysis of the precursor. The impregnation and pyrolysis may be repeated successively one or more times, for example in order to form several successive cycles of impregnation and pyrolysis.

Alternatively, the densification sub-step 8012 may be carried out by calefaction. The densification sub-step 8012 may comprise immersing the preform in a bath of carbon precursor, for example toluene. The densification sub-step 8012 may comprise a step of heating the submerged blank, for example by coupling with an inductor, so that the precursor in contact with the blank diffuses within it to form a PyC deposit by decomposition.

The method may comprise, for example after the step of supplying or obtaining 801, a step of storing 802 the blanks supplied or obtained, for example in the input storage area 7, for example arranged in stacks.

The method may comprise, for example after the providing or obtaining step 801, for example after the storing step 802, a step 803 of impregnating the blanks with the sol-gel type solution, the solution including a solvent and one or more compounds, for example blanks arranged in stacks, to obtain the impregnated blanks 15, for example by the impregnating means 8.

The process may comprise, for example subsequent to the impregnation step 803, a storage step 804 of the impregnated blanks, for example in the intermediate storage zone 9, for example arranged in stacks.

The process may comprise, for example after the providing or obtaining step 801, for example after the impregnation step 803, for example after the storing step 804 of the impregnated blanks, a step 805 of drying the impregnated blanks 15, the drying step comprising the drying process.

1. A diffuser for diffusing a gas flow within a stack of blanks of parts based on carbon/carbon composite impregnated with a sol-gel type solution, the sol-gel type solution comprising a solvent and one or more compounds, the gas flow enabling the solvent to be evaporated by heat transfer, each blank having a central through hole, the central holes passing through blanks of the stack of blanks forming a central well of the stack of blanks, the diffuser comprising a plurality of diffusion vanes each comprising a central end and a peripheral end, the diffusion vanes extending from a central cavity of the diffuser to a periphery of the diffuser,
each diffusion vane having a central through opening, the central through openings of the diffusion vanes forming the open central cavity of the diffuser, in order to form a gas inlet open upwardly when the diffuser is installed so as to be associated with the stack of blanks, a section of the central cavity decreasing from the gas inlet,
said diffusion vanes being adapted to extend at least partially into the central well when the diffuser is installed so as to be associated with the stack of blanks, the diffusion vanes being adapted to diffuse and homogenize over an entire height of the stack of blanks the gas flow flowing from the central well through the stack of blanks.

2. The diffuser according to claim 1, wherein the diffusion vanes each include an inclined section extending between the central end and the peripheral end, a peripheral diameter of the diffusion vanes being constant, for example.

3. The diffuser according to claim 1, wherein the diffuser is configured so that, when the diffuser is installed so as to be associated with the stack of blanks, the peripheral end of each diffusion vane faces an internal wall of a blank, so that the gas flow is directed towards a periphery between the blanks.

4. The diffuser according to claim 1, further comprising a deflector adapted to extend at least partially above the stack of blanks when the diffuser is installed so as to be associated with the stack of blanks, in order to guide the gas towards the central well of the stack of blanks, for example towards the central cavity of the diffuser.

5. The diffuser according to claim 1, further comprising one or more structural elements connecting the diffusion vanes to each other and to the deflector, the one or more structural elements including a plurality of rods.

6. A diffusion assembly comprising:
the diffuser according to claim 1, and
a base configured so that the diffuser rests on the base when installed so as to be associated with the stack of blanks.

7. A stack assembly comprising:
the diffuser according to claim 1, and
the blanks of parts based on the carbon/carbon composite impregnated with the sol-gel type solution, the solution comprising the solvent and the one or more compounds, the blanks being arranged in the stack of blanks, each blank having the central through hole, the central holes passing through the blanks of the stack of blanks forming the central well of the stack of blanks,
wherein
the diffuser is installed so as to be associated with the stack of blanks.
